(19) United States
(12) Patent Application Publication
(10) Pub. No.: US 2025/0126571 A1
(43) Pub. Date: Apr. 17, 2025

(54) CARRIER POWER LEVEL ADJUSTMENT

(71) Applicant: QUALCOMM Incorporated, San Diego, CA (US)

(72) Inventors: Anton RADIONOV, Plainsboro, NJ (US); Daniel James FLACCAVENTO, Pittstown, NJ (US); Joel Taylor GARRELL, Morristown, NJ (US); Anusha SHEELAVANT, Somerset, NJ (US)

(21) Appl. No.: 18/484,651

(22) Filed: Oct. 11, 2023

(51) Int. Cl. H04W 52/22; H04W 52/34; H04W 52/52

(52) U.S. Cl. CPC H04W 52/22; H04W 52/346; H04W 52/52

(57) ABSTRACT

Various aspects of the present disclosure generally relate to wireless communication. In some aspects, a wireless device may transmit in each carrier portion of a plurality of carrier portions spanning an available bandwidth configured for the device, a signal in full occupied bandwidth for the carrier portion. The wireless device may measure in each carrier portion of the plurality of carrier portions, a respective power level of the signal. The wireless device may select a reference power level from among the respective power levels for the plurality of carrier portions. The wireless device may adjust the respective power levels for one or more carrier portions of the plurality of carrier portions to match the reference power level. Numerous other aspects are described.

### FIELD OF THE DISCLOSURE

Aspects of the present disclosure generally relate to wireless communication and to techniques and apparatuses for carrier power level adjustment.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a wireless device. The method may include transmitting, by the wireless device, in each carrier portion of a plurality of carrier portions spanning an available bandwidth configured for the wireless device, a signal in full occupied bandwidth for the carrier portion. The method may include measuring, by the wireless device, in each carrier portion of the plurality of carrier portions, a respective power level of the signal. The method may include selecting, by the wireless device, a reference power level from among the respective power levels for the plurality of carrier portions. The method may include adjusting, by the wireless device, the respective power levels for one or more carrier portions of the plurality of carrier portions to match the reference power level.

Some aspects described herein relate to an apparatus for wireless communication at a wireless device. The apparatus may include one or more memories and one or more processors coupled to the one or more memories. The one or more processors may be individually or collectively and based at least in part on information stored in the one or more memories, configured to transmit in each carrier portion of a plurality of carrier portions spanning an available bandwidth configured for the wireless device, a signal in full occupied bandwidth for the carrier portion. The one or more processors may be configured to measure in each carrier portion of the plurality of carrier portions, a respective power level of the signal. The one or more processors may be configured to select a reference power level from among the respective power levels for the plurality of carrier portions. The one or more processors may be configured to adjust the respective power levels for one or more carrier portions of the plurality of carrier portions to match the reference power level.

Some aspects described herein relate to a non-transitory computer-readable medium that stores a set of instructions for wireless communication by a wireless device. The set of instructions, when executed by one or more processors of the wireless device, may cause the wireless device to transmit in each carrier portion of a plurality of carrier portions spanning an available bandwidth configured for the wireless device, a signal in full occupied bandwidth for the carrier portion. The set of instructions, when executed by one or more processors of the wireless device, may cause the wireless device to measure in each carrier portion of the plurality of carrier portions, a respective power level of the signal. The set of instructions, when executed by one or more processors of the wireless device, may cause the wireless device to select a reference power level from among the respective power levels for the plurality of carrier portions. The set of instructions, when executed by one or more processors of the wireless device, may cause the wireless device to adjust the respective power levels for one or more carrier portions of the plurality of carrier portions to match the reference power level.

Some aspects described herein relate to an apparatus for wireless communication. The apparatus may include means for transmitting in each carrier portion of a plurality of carrier portions spanning an available bandwidth configured for the apparatus, a signal in full occupied bandwidth for the carrier portion. The apparatus may include means for measuring in each carrier portion of the plurality of carrier portions, a respective power level of the signal. The apparatus may include means for selecting a reference power level from among the respective power levels for the plurality of carrier portions. The apparatus may include means for adjusting the respective power levels for one or more carrier portions of the plurality of carrier portions to match the reference power level.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a digital front end, in accordance with the present disclosure.

FIG. 5 is a diagram illustrating an example of performing undrooping, in accordance with the present disclosure.

FIG. 6 is a diagram illustrating an example of an undroop filter, in accordance with the present disclosure.

FIG. 7 is a diagram illustrating an example associated with undrooping a signal, in accordance with the present disclosure.

FIG. 8 is a diagram illustrating an example process performed, for example, at a wireless device or an apparatus of a wireless device, in accordance with the present disclosure.

FIG. 9 is a diagram of an example apparatus for wireless communication, in accordance with the present disclosure.

### DETAILED DESCRIPTION

A wireless device may have various components that prepare a signal for transmission. Some of these components may include a digital front end (DFE) that prepares a signal for a radio frequency (RF) transmit (Tx) chain that transmits the signal from an antenna/port. Due to the characteristics of the hardware and the methods of signal processing, there may be some gain imbalance (higher gain or lower gain) over frequency in the transmitted signal. This gain imbalance may be referred to as “droop.” This droop may cause differences in power levels between carrier portions (e.g., component carriers (CCs)) in a multi-carrier transmission configuration. The larger the allocated bandwidth (instantaneous bandwidth (IBW)), the stronger the droop effect. Droop will cause performance issues on the receiving end of a link. Ideally, for best link performance, CCs are expected to be of equal power when exiting the transmit antenna/port.

Sources of transmission droop may be the baseband (BB) signal, intermediate frequency (IF) conversion (if applicable), and the RF Tx chain. Transmission devices with a large IBW are particularly susceptible to droop. Such devices may include millimeter wave (mmWave) radio devices, given the high number of wide CCs and large IBW that are used. Some techniques address each source of droop separately. For example, one technique may involve characterizing BB droop and then calibrating IF and RF separately. However, due to the high number of BB, IF, and RF combinations, this a time-consuming task. In addition, during the droop compensation step (undrooping step), it is challenging to combine the undroop for all three sources, while at the same time providing the best possible accuracy for each operational set of IBW, number of CCs, and carrier frequencies. Inaccurate undrooping provides for a suboptimal signal.

According to various aspects described herein, a wireless device may calibrate or adjust for transmission droop from all droop sources (e.g., BB, IF, RF) at once rather than attempt to characterize and calibrate for the droop at each source separately. For example, the wireless device may transmit a signal in full occupied bandwidth of each carrier portion (e.g., CC, frequency bin) of the available bandwidth, such as in a sweep of the carrier portions that fill the available bandwidth. The wireless device may measure the respective power level for each carrier portion. The wireless device may select a reference power level from the respective power levels. The wireless device may adjust (undroop) the respective power level in each carrier portion as necessary to match (e.g., equal or fall within threshold of) the reference power level.

By adjusting for the droop per carrier portion and based at least in part on the output signal, the wireless device may be able to account for the droop from any combination of sources in one shot and with less complexity. This conserves time and signaling resources.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

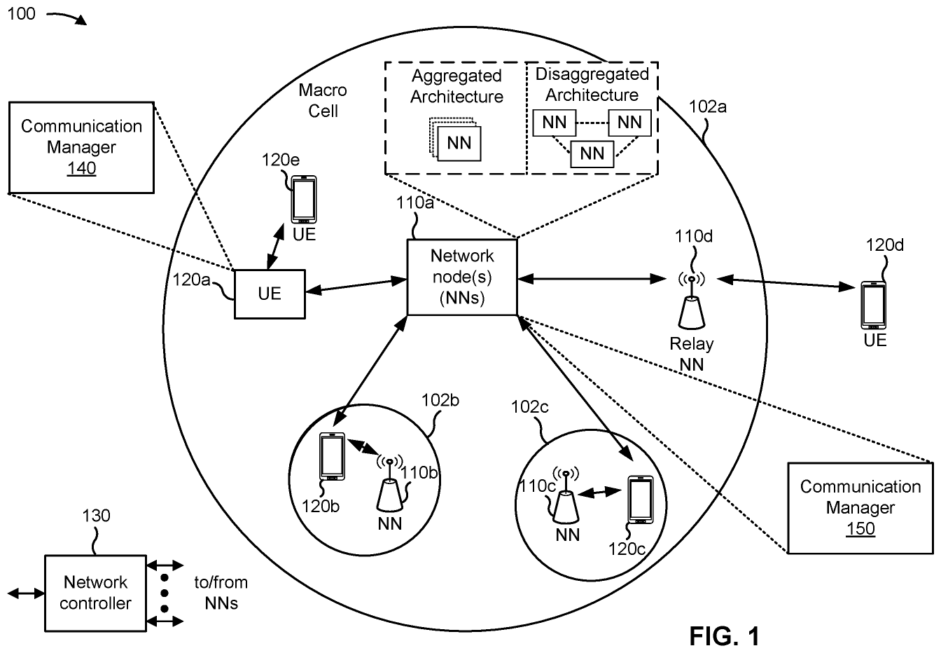

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a wireless device (e.g., a UE 120, a network node 110) may include a communication manager 140 or 150. As described in more detail elsewhere herein, the communication manager 140 or 150 may transmit in each carrier portion of a plurality of carrier portions spanning an available bandwidth configured for the wireless device, a signal in full occupied bandwidth for the carrier portion. The communication manager 140 or 150 may measure in each carrier portion of the plurality of carrier portions, a respective power level of the signal. The communication manager 140 or 150 may select a reference power level from among the respective power levels for the plurality of carrier portions. The communication manager 140 or 150 may adjust the respective power levels for one or more carrier portions of the plurality of carrier portions to match the reference power level. Additionally, or alternatively, the communication manager 140 or 150 may perform one or more other operations described herein.

As indicated above, FIG. 1 is provided as an example. Other examples may differ from what is described with regard to FIG. 1.

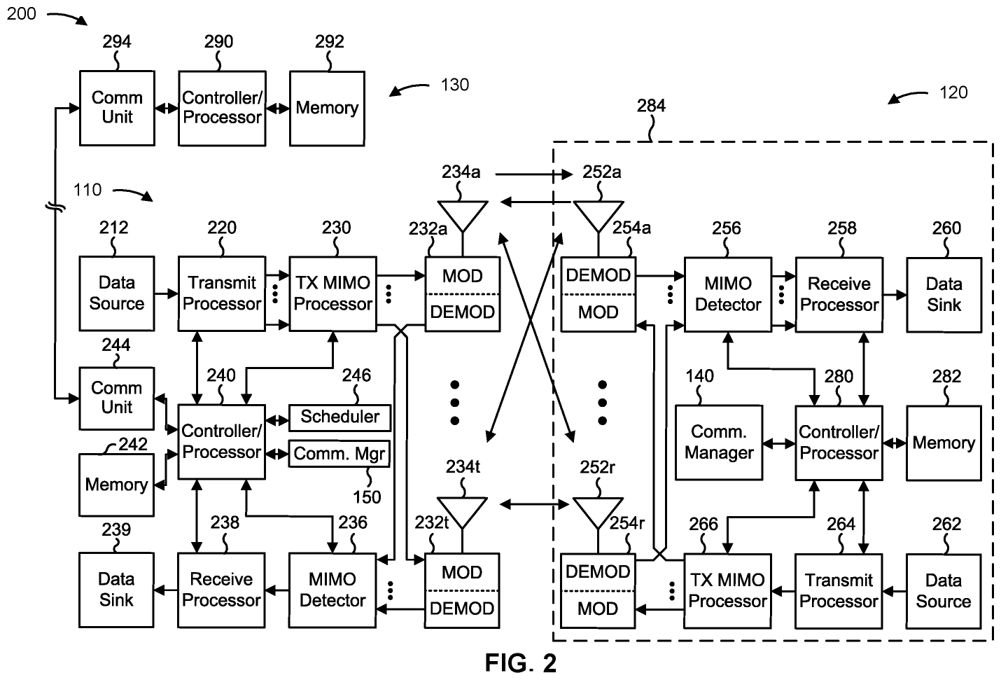

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

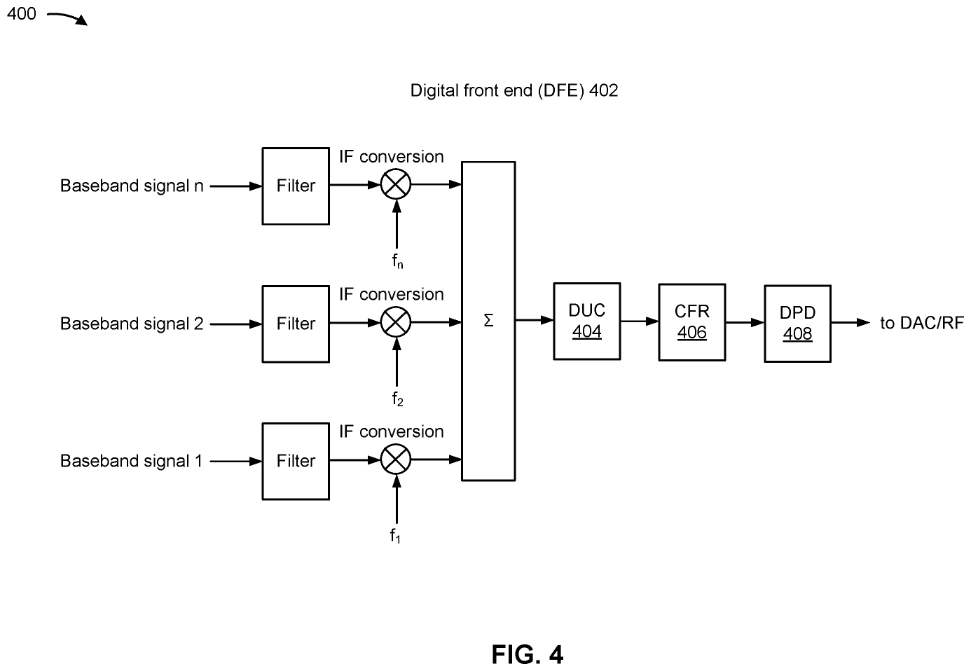

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-9).

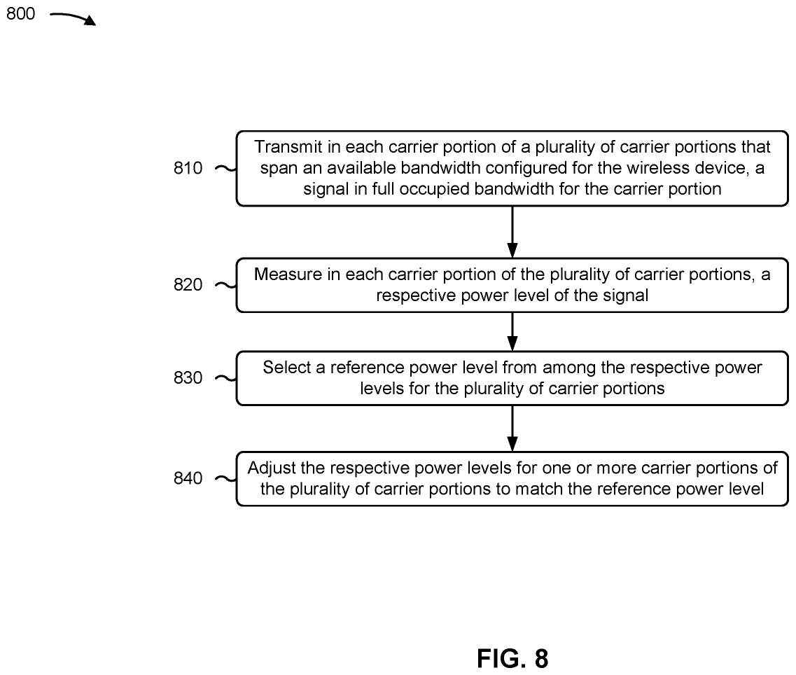

The controller/processor 240 of the network node 110, the controller/processor 280 of the UE 120, and/or any other component(s) of FIG. 2 may perform one or more techniques associated with equalizing carrier power levels, as described in more detail elsewhere herein. In some aspects, the wireless device described herein is the network node 110, is included in the network node 110, or includes one or more components of the network node 110 shown in FIG. 2. In some aspects, the wireless device described herein is the UE 120, is included in the UE 120, or includes one or more components of the UE 120 shown in FIG. 2. For example, the controller/processor 240 of the network node 110, the controller/processor 280 of the UE 120, and/or any other component(s) of FIG. 2 may perform or direct operations of, for example, process 800 of FIG. 8 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8 and/or other processes as described herein. In some examples, executing instructions may include running the instructions, converting the instructions, compiling the instructions, and/or interpreting the instructions, among other examples.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

In some aspects, a wireless device (e.g., a UE 120, a network node 110) includes means for transmitting, by the wireless device, in each carrier portion of a plurality of carrier portions spanning an available bandwidth configured for the wireless device, a signal in full occupied bandwidth for the carrier portion; means for measuring, by the wireless device, in each carrier portion of the plurality of carrier portions, a respective power level of the signal; means for selecting, by the wireless device, a reference power level from among the respective power levels for the plurality of carrier portions; and/or means for adjusting, by the wireless device, the respective power levels for one or more carrier portions of the plurality of carrier portions to match the reference power level. In some aspects, the means for the wireless device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the wireless device to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

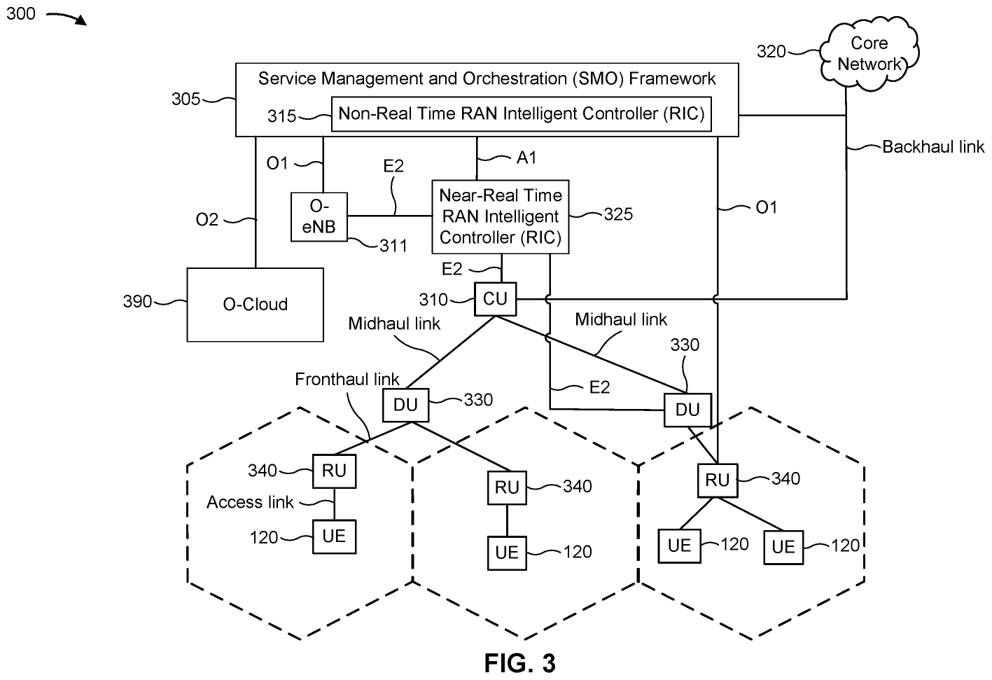

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-cNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of a DFE, in accordance with the present disclosure. Example 400 shows a DFE 402 that may be implemented in transmit processor 220 or 264, TX MIMO processor 230 or 266, modem 234 or 254, and/or controller/processor 240 or 280, as described above in connection with FIG. 2. In some aspects, the DFE 402 and an RF Tx chain may be implemented in UE 120 for transmitting data (e.g., uplink data, an uplink reference signal, and/or uplink control information (UCI)) to a network node 110 on an uplink channel. In some aspects, the DFE 402 may be implemented in network node 110 for transmitting data (e.g., downlink data, downlink reference signal, and/or downlink control information (DCI) to a UE 120).

The DFE 402 may include components that condition a baseband signal to be ready for the RF Tx chain. The DFE 402 may combine baseband signals that have been filtered and IF converted into a component for digital upconversion (DUC) 404. The DUC 404 may include signal processing blocks that create and condition a composite signal for multiple individual carrier portions (e.g., CCs) of a spectrum. The DUC 404 may operate per antenna per carrier portion.

The DUC 404 may feed the conditioned signal to a component for crest factor reduction (CFR) 406, which reduces the peak to average power ratio (PAPR) of an aggregated signal. The signal may be processed by a component for digital predistortion (DPD) 408, which implements a function that prepares the signal for power amplification. Other compensation or controls for in-phase and quadrature-phase (IQ) imbalance or gain inefficiencies may be applied before the signal is provided to the digital to analog (DAC) converter and the RF Tx chain, which prepares the signal for transmission on the antennas.

Due to the characteristics of the hardware and the methods of signal processing, there may be some gain imbalance (higher gain or lower gain) over frequency in the transmitted signal. This gain imbalance may be referred to as “droop.” This droop may cause differences in power levels between CCs in a multi-carrier transmission configuration. The larger the allocated bandwidth (e.g., IBW), the stronger the droop effect. Droop will cause performance issues on the receiving end of the link. Ideally, for best link performance, all CCs are expected to be of equal power when exiting the transmit antenna/port.

Sources of transmission droop may be the BB signal, the IF conversion (if applicable), and the RF Tx chain. Transmission devices with a large IBW are particularly susceptible to droop. Such devices may include mmWave radio devices, given the high number of wide CCs and large IBW that are used. Some techniques address each source of droop separately. For example, one technique may involve characterizing BB droop and then calibrating IF and RF separately. However, due to the high number of BB, IF, and RF combinations, this a time-consuming task. In addition, during the droop compensation step (undrooping step), it is challenging to combine the undroop for all three sources, while at the same time providing the best possible accuracy for each operational set of IBW, number of CCs, and carrier frequencies. Inaccurate undrooping provides for a suboptimal signal.

The number and arrangement of components shown in FIG. 4 are provided as an example. In practice, there may be additional components, fewer components, different components, or differently arranged components than those shown in FIG. 4. Furthermore, two or more components shown in FIG. 4 may be implemented within a single component, or a single component shown in FIG. 4 may be implemented as multiple, distributed components. Additionally, or alternatively, a set of components (e.g., one or more components) shown in FIG. 4 may perform one or more functions described as being performed by another set of components shown in FIG. 4.

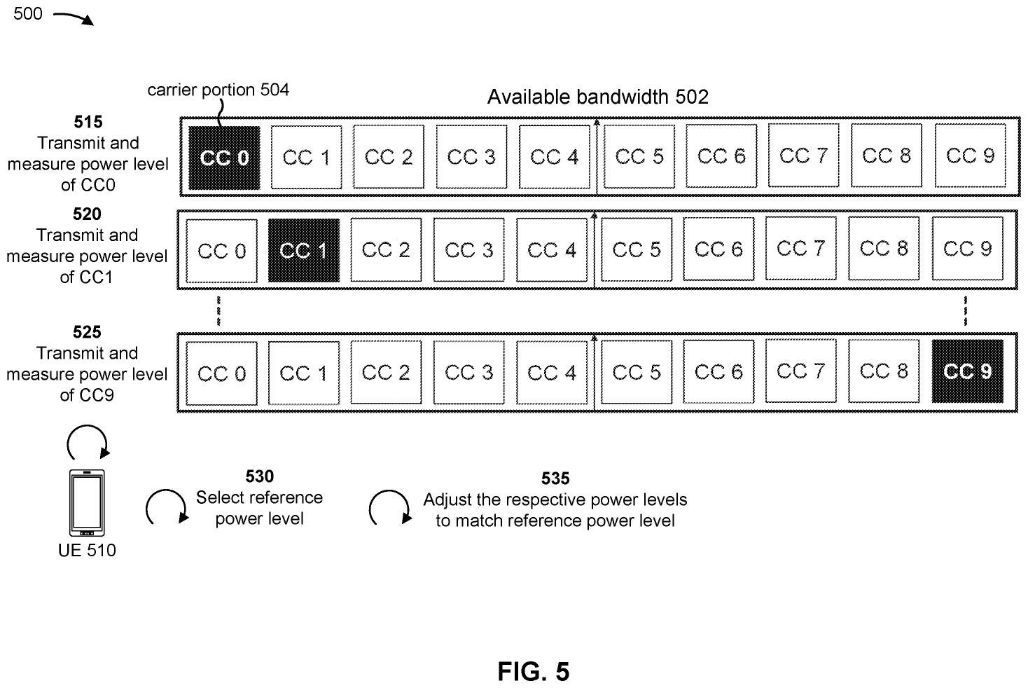

FIG. 5 is a diagram illustrating an example 500 of performing undrooping, in accordance with the present disclosure.

According to various aspects described herein, a wireless device may calibrate or adjust for transmission droop from all droop sources (e.g., BB, IF, RF) at once rather than attempt to characterize and calibrate for the droop at each droop source separately. For example, the wireless device may transmit a signal in full occupied bandwidth of each carrier portion (e.g., CC, frequency bin) of the available bandwidth, such as in a sweep of the carrier portions that fill the available bandwidth. The wireless device may measure the respective power level for each carrier portion. The wireless device may select a reference power level from the respective power levels. The wireless device may adjust (undroop) the respective power level in each carrier portion as necessary to match the reference power level. This undrooping may take place at a configuration time after the IBW, the CCs, and the local oscillator (LO) have all been configured and/or when the wireless device is in an operational mode. By adjusting for the droop per carrier portion and based at least in part on the output signal, the wireless device may be able to account for the droop from any combination of sources in one shot and with less complexity. This conserves time and signaling resources.

Example 500 shows an example of undrooping based on measuring the transmit signal for each carrier portion. An available bandwidth 502 (e.g., IBW, configured bandwidth, allocated bandwidth) may be divided into multiple carrier portions, and the carrier portions may be contiguous. A carrier portion may be a CC or a frequency bin (frequency range). The CCs may be, for example, 20 MHz. If the CCs are larger, such as 100 MHz, a CC may be divided into two or more bandwidths or frequency bins, where each divided portion is a carrier portion. A wireless device, such as UE 510, may be configured to use a maximum number of carrier portions of the available bandwidth 502.

The UE 510 may set digital and analog gains as in an operational mode. The UE 510 may prepare to turn on and off one carrier portion at a time. As shown by reference number 515, the UE 510 may transmit and measure a first signal of a first carrier portion 504 (e.g., CC 0) of the available bandwidth 502. The UE 510 may measure the signal to obtain the power level, using an in-circuit power detector placed before the DAC. The power detector may be after the power amplifier (PA). No external equipment is necessary. The UE 510 may transmit the signal with a transmit power that can be detected by the power detector. In some aspects, the UE 510 may use a maximum transmit power. The UE 510 may transmit the signal in full occupied bandwidth (e.g., all of the bandwidth) of the carrier portion 504 to obtain the most accurate power level. The UE 510 may keep the probability of detection (PDET) measurements in range by increasing a DAC setpoint for carrier portions that are further from the center of the available bandwidth 502.

As shown by reference number 520, the UE 510 may then transmit and measure a second signal in full occupied bandwidth of a second carrier portion (e.g., CC 1) of the available bandwidth 502. As shown by reference number 525, the UE 510 may repeat this transmission and measuring until the last carrier portion (e.g., CC 9) is measured. The UE 510 may have a measurement of the power level for each carrier portion.

As shown by reference number 530, the UE 510 may select a reference power level from among the respective power levels of the carrier portions. In some aspects, the UE 510 may select a power level that is at or near a target power level (e.g., closest to the LO, based on hardware characteristics). In some aspects, the UE 510 may select the power level that most frequently occurs among the carrier portions (such that less power levels are to be adjusted).

As shown by reference number 535, the UE 510 may adjust the respective power level at each carrier portion to match the reference power level. That is, the UE 510 may equalize the power levels across the carrier portions. This may include calculating the undroop needed for each carrier portion and applying a filter or changing a parameter to cancel the droop. The UE 510 may adjust power level parameters in frequency bins of the carrier portions. The adjustments may be an increase in gain or a decrease in gain as the gain imbalances may be decreases or increases in the gain. The adjustments may be made at an undroop filter of a DFE. The UE 510 may transmit a signal with the power equalized across carrier portions. With droop removed in one shot, the UE 510 may transmit a better signal without the complexities of removing droop for different droop sources separately.

While example 500 involves the wireless device being in an operational mode, the undrooping may be applied while connected to a network node, while not connected to a network node, or at the factory. In either scenario, the wireless device may store undrooping parameters or adjustment information for the carrier portions in a data structure (e.g., look up table (LUT)) in non-volatile (NV) memory. For example, the LUT may map bin indices to undroop values. The wireless device may look up an apply the information as necessary.

As indicated above, FIG. 5 is provided as an example. Other examples may differ from what is described with regard to FIG. 5.

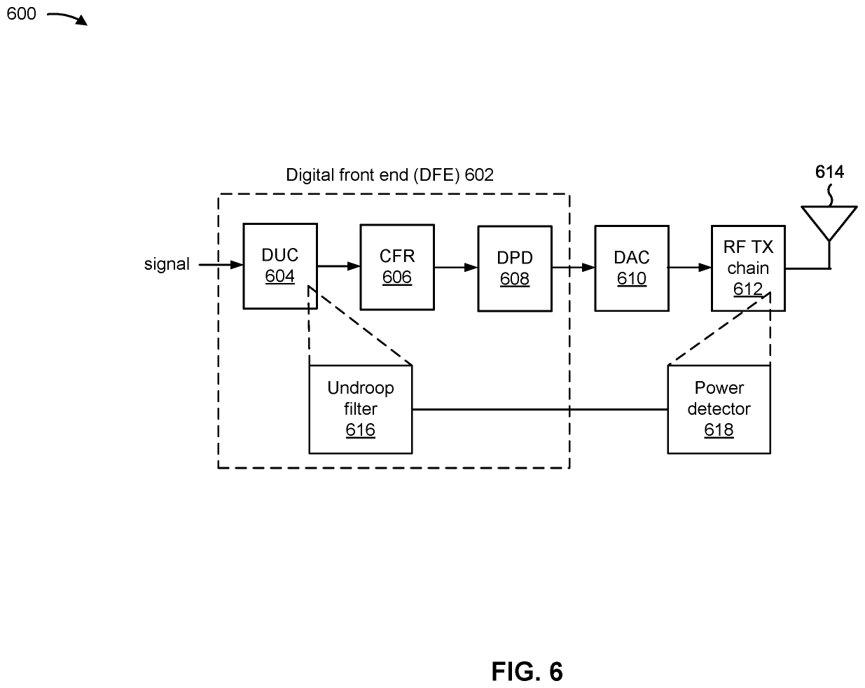

FIG. 6 is a diagram illustrating an example 600 of an undroop filter, in accordance with the present disclosure. Example 600 shows a DFE 602 with a DUC 604, CFR 606, and DPD 608. The DFE 602 may provide a signal to a DAC 610 and an RF Tx chain 612 that is coupled to an antenna array 614. These components may be in a wireless device, such as UE 510 (e.g., UE 120) or a network node 110.

The DFE 602 may include an undroop filter 616 that is configured to equalize gain imbalances over frequency. The undroop filter 616 may be a component of the DUC 604, such as an impulse response filter. The undroop filter 616 may control the transmission of signal and the measurement of the signals. The undroop filter 616 may obtain power level measurements from a power detector 618 located within the RF Tx chain 612. The undroop filter 616 may make the power level adjustments to frequency bins of the carrier portions.

As indicated above, FIG. 6 is provided as an example. Other examples may differ from what is described with regard to FIG. 6.

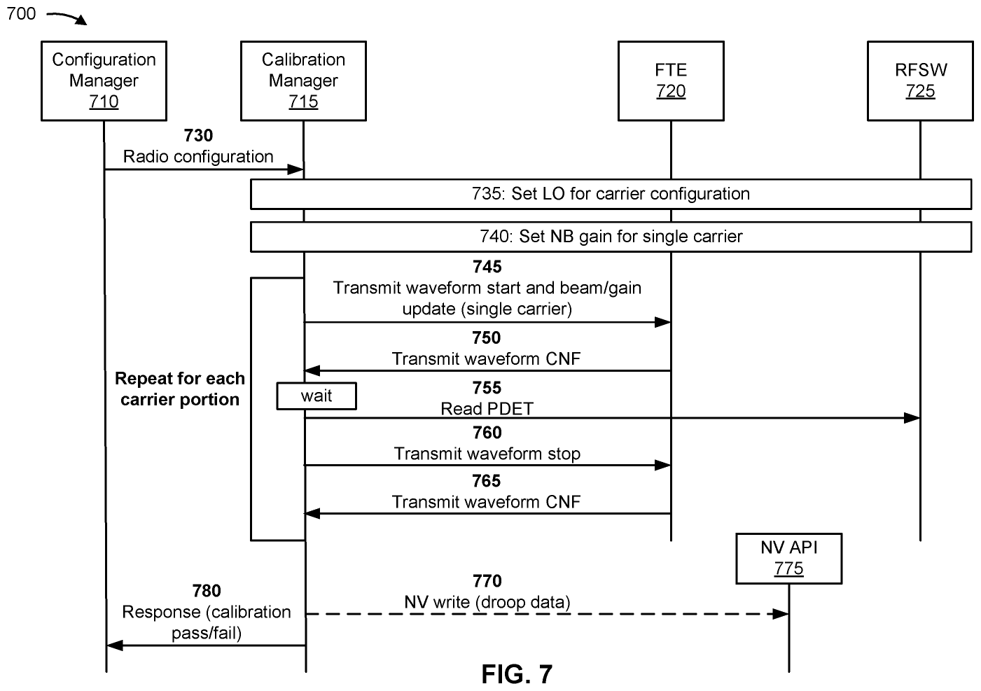

FIG. 7 is a diagram illustrating an example 700 associated with undrooping a signal, in accordance with the present disclosure. A wireless device (e.g., UE 120, network node 110) may include an undroop filter (e.g., undroop filter 616). The undroop filter may include or may communicate with a configuration manager 710 that configured the wireless device, a calibration manager 715 that calibrates components of the wireless device, front test equipment (FTE) 720 that is used for testing and measurement of signal and signal components, and RF software (RFSW) 725 that controls RF components, including a power detector.

As shown by reference number 730, the configuration manager 710 may provide a radio configuration to the calibration manager 715. The radio configuration may indicate that the wireless device is to transmit signals in the plurality of carrier portions and adjust the respective power levels to match the reference power level. The wireless device may receive such a configuration from another device, such as a network node. As shown by reference number 735, the calibration manager 715 may set the LO for carrier configuration. As shown by reference number 740, the calibration manager 715 may set the narrowband (NB) gain for a single carrier.

The calibration manager may turn on, measure, and turn off the waveform for each carrier portion. As shown by reference number 745, the calibration manager 715 may transmit a waveform start message to the FTE 720. The message may include a beam/gain update for a single carrier. As shown by reference number 750, the FTE 720 may transmit a confirmation message. The calibration manager 715 may wait and transmit a read PDET message, as shown by reference number 755. The calibration manager 715 may cause the undroop filter to obtain droop data for the carrier portion. As shown by reference number 760, the calibration manager 715 may transmit a waveform stop message. As shown by reference number 765, the FTE 720 may transmit a confirmation message.

In some aspects, as shown by reference number 770, the calibration manager 715 may write the droop data to NV by transmitting a message to an NV application programming interface (API) 775. As shown by reference number 780, the calibration manager 715 may send a response to the configuration manager 710.

As indicated above, FIG. 7 is provided as an example. Other examples may differ from what is described with respect to FIG. 7.

FIG. 8 is a diagram illustrating an example process 800 performed, for example, at a wireless device or an apparatus of a wireless device, in accordance with the present disclosure. Example process 800 is an example where the apparatus or the wireless device (e.g., UE 120, UE 510, network node 110) performs operations associated with carrier power level adjustment.

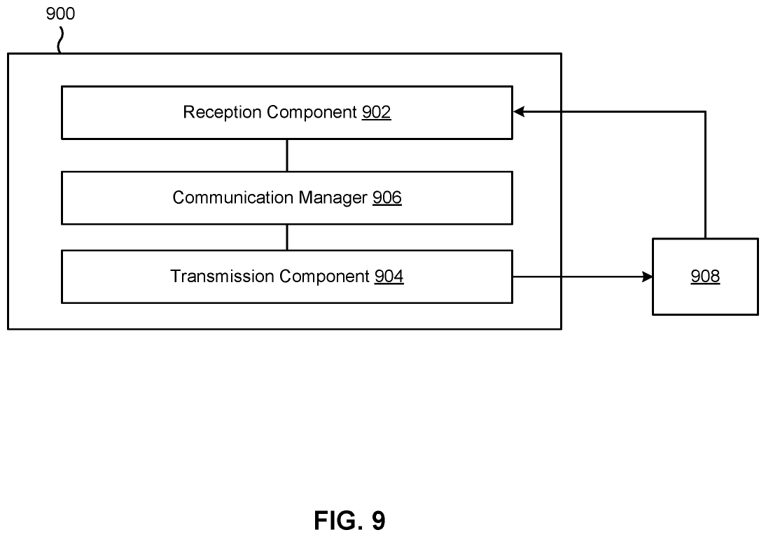

As shown in FIG. 8, in some aspects, process 800 may include transmitting in each carrier portion of a plurality of carrier portions spanning an available bandwidth configured for the wireless device, a signal in full occupied bandwidth for the carrier portion (block 810). For example, the wireless device (e.g., using transmission component 904 and/or communication manager 906, depicted in FIG. 9) may transmit in each carrier portion of a plurality of carrier portions spanning an available bandwidth configured for the wireless device, a signal in full occupied bandwidth for the carrier portion, as described above.

As further shown in FIG. 8, in some aspects, process 800 may include measuring in each carrier portion of the plurality of carrier portions, a respective power level of the signal (block 820). For example, the wireless device (e.g., using communication manager 906, depicted in FIG. 9) may measure in each carrier portion of the plurality of carrier portions, a respective power level of the signal, as described above.

As further shown in FIG. 8, in some aspects, process 800 may include selecting a reference power level from among the respective power levels for the plurality of carrier portions (block 830). For example, the wireless device (e.g., using communication manager 906, depicted in FIG. 9) may select a reference power level from among the respective power levels for the plurality of carrier portions, as described above.

As further shown in FIG. 8, in some aspects, process 800 may include adjusting the respective power levels for one or more carrier portions of the plurality of carrier portions to match the reference power level (block 840). For example, the wireless device (e.g., using communication manager 906, depicted in FIG. 9) may adjust the respective power levels for one or more carrier portions of the plurality of carrier portions to match the reference power level, as described above.

Process 800 may include additional aspects, such as any single aspect or any combination of aspects described below and/or in connection with one or more other processes described elsewhere herein.

In a first aspect, process 800 includes transmitting, by the wireless device, a communication in multiple carrier portions of the plurality of carrier portions using adjusted power levels for the multiple carrier portions.

In a second aspect, alone or in combination with the first aspect, the transmitting and the measuring are performed for each carrier portion one at a time in a sweep of the available bandwidth.

In a third aspect, alone or in combination with one or more of the first and second aspects, measuring the respective power levels includes measuring the respective power levels using an in-circuit power detector.

In a fourth aspect, alone or in combination with one or more of the first through third aspects, adjusting the respective power levels for the one or more carrier portions includes adjusting the respective power levels at an undroop filter in a digital front end of the wireless device, and the undroop filter is configured to equalize gain imbalances over frequency.

In a fifth aspect, alone or in combination with one or more of the first through fourth aspects, adjusting the respective power levels at the undroop filter includes adjusting the respective power levels in one or more frequency bins corresponding to the one or more carrier portions.

In a sixth aspect, alone or in combination with one or more of the first through fifth aspects, adjusting the respective power levels at the undroop filter includes obtaining adjusted power levels from a stored data structure.

In a seventh aspect, alone or in combination with one or more of the first through sixth aspects, the transmitting, the measuring, and the adjusting are performed while the wireless device is in an operational mode.

In an eighth aspect, alone or in combination with one or more of the first through seventh aspects, process 800 includes receiving a configuration that indicates that the wireless device is to transmit signals in the plurality of carrier portions and adjust the respective power levels to match the reference power level.

In a ninth aspect, alone or in combination with one or more of the first through eighth aspects, transmitting the signal includes transmitting the signal in the full occupied bandwidth at a transmit power that is within range of a power detector of the wireless device.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a wireless device (UE 120, network node 110), or a wireless device may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 or 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 1-7. Additionally, or alternatively, the apparatus 900 may be configured to perform one or more processes described herein, such as process 800 of FIG. 8. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit in each carrier portion of a plurality of carrier portions spanning an available bandwidth configured for the wireless device, a signal in full occupied bandwidth for the carrier portion. The communication manager 906 may measure in each carrier portion of the plurality of carrier portions, a respective power level of the signal. The communication manager 906 may select a reference power level from among the respective power levels for the plurality of carrier portions. The communication manager 906 may adjust the respective power levels for one or more carrier portions of the plurality of carrier portions to match the reference power level.

The transmission component 904 may transmit a communication in multiple carrier portions of the plurality of carrier portions using adjusted power levels for the multiple carrier portions. The reception component 902 may receive a configuration that indicates that the wireless device is to transmit signals in the plurality of carrier portions and adjust the respective power levels to match the reference power level.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a wireless device, comprising: transmitting, by the wireless device, in each carrier portion of a plurality of carrier portions spanning an available bandwidth configured for the wireless device, a signal in full occupied bandwidth for the carrier portion; measuring, by the wireless device, in each carrier portion of the plurality of carrier portions, a respective power level of the signal; selecting, by the wireless device, a reference power level from among the respective power levels for the plurality of carrier portions; and adjusting, by the wireless device, the respective power levels for one or more carrier portions of the plurality of carrier portions to match the reference power level.

Aspect 2: The method of Aspect 1, further comprising transmitting, by the wireless device, a communication in multiple carrier portions of the plurality of carrier portions using adjusted power levels for the multiple carrier portions.

Aspect 3: The method of any of Aspects 1-2, wherein the transmitting and the measuring are performed for each carrier portion one at a time in a sweep of the available bandwidth.

Aspect 4: The method of any of Aspects 1-3, wherein measuring the respective power levels comprises measuring the respective power levels using an in-circuit power detector.

Aspect 5: The method of any of Aspects 1-4, wherein adjusting the respective power levels for the one or more carrier portions comprises adjusting the respective power levels at an undroop filter in a digital front end of the wireless device, and wherein the undroop filter is configured to equalize gain imbalances over frequency.

Aspect 6: The method of Aspect 5, wherein adjusting the respective power levels at the undroop filter comprises adjusting the respective power levels in one or more frequency bins corresponding to the one or more carrier portions.

Aspect 7: The method of Aspect 5, wherein adjusting the respective power levels at the undroop filter comprises obtaining adjusted power levels from a stored data structure.

Aspect 8: The method of any of Aspects 1-7, wherein the transmitting, the measuring, and the adjusting are performed while the wireless device is in an operational mode.

Aspect 9: The method of any of Aspects 1-8, further comprising receiving a configuration indicating the wireless device is to transmit signals in the plurality of carrier portions and adjust the respective power levels to match the reference power level.

Aspect 10: The method of any of Aspects 1-9, wherein transmitting the signal comprises transmitting the signal in the full occupied bandwidth at a transmit power within range of a power detector of the wireless device.

Aspect 11: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-10.

Aspect 12: An apparatus for wireless communication at a device, the apparatus comprising one or more memories and one or more processors coupled to the one or more memories, the one or more processors configured to cause the device to perform the method of one or more of Aspects 1-10.

Aspect 13: An apparatus for wireless communication, the apparatus comprising at least one means for performing the method of one or more of Aspects 1-10.

Aspect 14: A non-transitory computer-readable medium storing code for wireless communication, the code comprising instructions executable by one or more processors to perform the method of one or more of Aspects 1-10.

Aspect 15: A non-transitory computer-readable medium storing a set of instructions for wireless communication, the set of instructions comprising one or more instructions that, when executed by one or more processors of a device, cause the device to perform the method of one or more of Aspects 1-10.

Aspect 16: A device for wireless communication, the device comprising a processing system that comprises one or more processors and one or more memories coupled with the one or more processors, the processing system configured to cause the device to perform the method of one or more of Aspects 1-10.

Aspect 17: An apparatus for wireless communication at a device, the apparatus comprising one or more memories and one or more processors coupled to the one or more memories, the one or more processors individually or collectively configured to cause the device to perform the method of one or more of Aspects 1-10.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a wireless device, comprising:
one or more memories; and
one or more processors, the one or more processors, individually or collectively and based at least in part on information stored in the one or more memories, being configured to:
transmit in each carrier portion of a plurality of carrier portions spanning an available bandwidth configured for the wireless device, a signal in full occupied bandwidth for the carrier portion;
measure in each carrier portion of the plurality of carrier portions, a respective power level of the signal;
select a reference power level from among the respective power levels for the plurality of carrier portions; and
adjust the respective power levels for one or more carrier portions of the plurality of carrier portions to match the reference power level.

2. The apparatus of claim 1, wherein the one or more processors are individually or collectively configured to transmit a communication in multiple carrier portions of the plurality of carrier portions using adjusted power levels for the multiple carrier portions.

3. The apparatus of claim 1, wherein the one or more processors are individually or collectively configured to transmit the signal and measure the respective power level of the signal for each carrier portion one at a time in a sweep of the available bandwidth.

4. The apparatus of claim 1, wherein to measure the respective power levels, the one or more processors are individually or collectively configured to measure the respective power levels using an in-circuit power detector.

5. The apparatus of claim 1, wherein to adjust the respective power levels for the one or more carrier portions, the one or more processors are individually or collectively configured to adjust the respective power levels at an undroop filter in a digital front end of the wireless device, and wherein the undroop filter is configured to equalize gain imbalances over frequency.

6. The apparatus of claim 5, wherein to adjust the respective power levels at the undroop filter, the one or more processor are individually or collectively configured to adjust the respective power levels in one or more frequency bins corresponding to the one or more carrier portions.

7. The apparatus of claim 5, wherein to adjust the respective power levels at the undroop filter, the one or more processors are individually or collectively configured to obtain adjusted power levels from a stored data structure.

8. The apparatus of claim 1, wherein the one or more processors are individually or collectively configured to:
transmit the signal and measure the respective power level of the signal for each carrier portion while the wireless device is in an operational mode; and
adjust the respective power levels for the one or more carrier portions while the wireless device is in the operational mode.

9. The apparatus of claim 1, wherein the one or more processors are individually or collectively configured to receive a configuration indicating the wireless device is to transmit signals in the plurality of carrier portions and adjust the respective power levels to match the reference power level.

10. The apparatus of claim 1, wherein to transmit the signal, the one or more processors are individually or collectively configured to transmit the signal in the full occupied bandwidth at a transmit power within range of a power detector of the wireless device.

11. A method of wireless communication performed by a wireless device, comprising:
transmitting, by the wireless device, in each carrier portion of a plurality of carrier portions spanning an available bandwidth configured for the wireless device, a signal in full occupied bandwidth for the carrier portion;
measuring, by the wireless device, in each carrier portion of the plurality of carrier portions, a respective power level of the signal;
selecting, by the wireless device, a reference power level from among the respective power levels for the plurality of carrier portions; and
adjusting, by the wireless device, the respective power levels for one or more carrier portions of the plurality of carrier portions to match the reference power level.

12. The method of claim 11, further comprising transmitting, by the wireless device, a communication in multiple carrier portions of the plurality of carrier portions using adjusted power levels for the multiple carrier portions.

13. The method of claim 11, wherein the transmitting and the measuring are performed for each carrier portion one at a time in a sweep of the available bandwidth.

14. The method of claim 11, wherein measuring the respective power levels comprises measuring the respective power levels using an in-circuit power detector.

15. The method of claim 11, wherein adjusting the respective power levels for the one or more carrier portions comprises adjusting the respective power levels at an undroop filter in a digital front end of the wireless device, and wherein the undroop filter is configured to equalize gain imbalances over frequency.

16. The method of claim 15, wherein adjusting the respective power levels at the undroop filter comprises adjusting the respective power levels in one or more frequency bins corresponding to the one or more carrier portions.

17. The method of claim 15, wherein adjusting the respective power levels at the undroop filter comprises obtaining adjusted power levels from a stored data structure.

18. The method of claim 11, wherein the transmitting, the measuring, and the adjusting are performed while the wireless device is in an operational mode.

19. The method of claim 11, further comprising receiving a configuration indicating the wireless device is to transmit signals in the plurality of carrier portions and adjust the respective power levels to match the reference power level.

20. The method of claim 11, wherein transmitting the signal comprises transmitting the signal in the full occupied bandwidth at a transmit power within range of a power detector of the wireless device.

21. A non-transitory computer-readable medium storing a set of instructions for wireless communication, the set of instructions comprising:
one or more instructions that, when executed by one or more processors of a wireless device, cause the wireless device to:
transmit in each carrier portion of a plurality of carrier portions spanning an available bandwidth configured for the wireless device, a signal in full occupied bandwidth for the carrier portion;
measure in each carrier portion of the plurality of carrier portions, a respective power level of the signal;
select a reference power level from among the respective power levels for the plurality of carrier portions; and
adjust the respective power levels for one or more carrier portions of the plurality of carrier portions to match the reference power level.

22. The non-transitory computer-readable medium of claim 21, wherein the one or more instructions, that cause the wireless device to measure the respective power levels, cause the wireless device to measure the respective power levels using an in-circuit power detector.

23. The non-transitory computer-readable medium of claim 21, wherein the one or more instructions, that cause the wireless device adjust the respective power levels for the one or more carrier portions, cause the wireless device to adjust the respective power levels at an undroop filter in a digital front end of the wireless device, and wherein the undroop filter is configured to equalize gain imbalances over frequency.

24. The non-transitory computer-readable medium of claim 23, wherein the one or more instructions, that cause the wireless device to adjust the respective power levels at the undroop filter, cause the wireless device to adjust the respective power levels in one or more frequency bins corresponding to the one or more carrier portions.

25. The non-transitory computer-readable medium of claim 23, wherein the one or more instructions, that cause the wireless device to adjust the respective power levels at the undroop filter, cause the wireless device to obtain adjusted power levels from a stored data structure.

26. An apparatus for wireless communication, comprising:
means for transmitting in each carrier portion of a plurality of carrier portions spanning an available bandwidth configured for the apparatus, a signal in full occupied bandwidth for the carrier portion;
means for measuring in each carrier portion of the plurality of carrier portions, a respective power level of the signal;
means for selecting a reference power level from among the respective power levels for the plurality of carrier portions; and
means for adjusting the respective power levels for one or more carrier portions of the plurality of carrier portions to match the reference power level.

27. The apparatus of claim 26, wherein the means for measuring the respective power levels comprises means for measuring the respective power levels using an in-circuit power detector.

28. The apparatus of claim 26, wherein the means for adjusting the respective power levels for the one or more carrier portions comprises means for adjusting the respective power levels at an undroop filter in a digital front end of the apparatus, and wherein the undroop filter is configured to equalize gain imbalances over frequency.

29. The apparatus of claim 28, wherein the means for adjusting the respective power levels at the undroop filter comprises means for obtaining adjusted power levels from a stored data structure.

30. The apparatus of claim 26, further comprising means for receiving a configuration indicating the apparatus is to transmit signals in the plurality of carrier portions and adjust the respective power levels to match the reference power level.
